(19) United States
(12) Patent Application Publication
(10) Pub. No.: US 2015/0140467 A1
(43) Pub. Date: May 21, 2015

(54) FUEL CELL WITH IMPROVED ELECTRIC INSULATION

(71) Applicant: AREVA Stockage d'Energie, Aix en Provence (FR)

(72) Inventor: Christian Quintieri, Aix en Provence (FR)

(21) Appl. No.: 14/413,619

(22) PCT Filed: Jul. 10, 2013
(86) PCT No.: PCT/EP2013/064538

§ 371 Date: Jan. 8, 2015

(30) Foreign Application Priority Data
Jul. 10, 2012 (FR) 12 56638

(51) Int. Cl. H01M 8/10; H01M 8/24

(52) U.S. Cl. CPC H01M 8/1004; H01M 8/2485; H01M 2008/1095; H01M 2300/0082
USPC 429/465; 429/483

(57) ABSTRACT

A fuel cell is provided. The fuel cell includes a stack of at least one electrochemical cell, suitable for generating an electric current from an oxidation-reduction reaction between an oxidizing fluid and a reducing fluid, the or each cell including an anode conductive plate, delimiting a channel for circulation of the reducing fluid, a cathode conductive plate, delimiting a channel for circulation of the oxidizing fluid, and an ion exchanger membrane interposed between the conductive plates, the membrane forming a barrier for free electrons. The membrane may be positioned relatively to the conductive plates so that an outer peripheral edge of the membrane juts out towards the outside of the stack relatively to the conductive plates, so as to lengthen air leak lines between the conductive plates.

The present invention relates to a fuel cell, of the type comprising a stack of at least one electrochemical cell, suitable for generating electric current from an oxidation-reduction reaction between an oxidizing fluid and a reducing fluid, said or each cell comprising an anode conductive plate, delimiting a channel for circulation of the reducing fluid, a cathode conductive plate, delimiting a channel for circulation of the oxidizing fluid, and an ion-exchange membrane interposed between the conductive plates, said membrane forming a barrier for free electrons.

### BACKGROUND

Such fuel cells are known and are an ecological solution for providing electric energy.

A problem encountered on certain fuel cells is the short-circuiting of the conductive plates. When such an event occurs, the fuel cell cannot operate and even risks being damaged definitively.

In order to avoid the occurrence of such short-circuits, it is possible to extend the ion-exchange membrane outside the active area of the cell where the oxidation-reduction reaction occurs. Thus, the outer peripheral edge of the ion-exchange membrane generally is flush with the outer peripheral edge of the conductive plates. A gasket is most often interposed between the membrane and each conductive plate for ensuring the seal, this gasket contributing to electric insulation of the plates.

However, this solution does not give satisfaction, insofar that the assembly formed with the gasket and the ion-exchange membrane is generally too thin for ensuring good electric insulation between the conductive plates. Further, the leak lines in air on the outside of the stack are very short and, as the fuel cells are generally used in a humid atmosphere, there exists a significant risk that dielectric breakdown occurs in the air causing a short-circuit between the conductive plates. Finally, it is possible, with an operation in view for handling the fuel cell, an outer conductive element will be accommodated between the conductive plates and forms a short-circuit between these plates.

A solution for compensating for the lack of thickness of the assembly formed by the membrane and the gaskets is provided by JP 2002 352417, which proposes deposition of an electric insulating material at the surface of the conductive plates, around the active area. However, such a deposition of insulating material on conductive plates is a costly operation.

In order to protect the fuel cell from outer conductive elements and to avoid dielectric breakdowns in air, it is possible to coat the stack in an insulating resin. This solution is, however, highly restrictive, to the extent that it imposes an additional operation in the manufacturing of the fuel cell, interferes with heat dissipation when operating, and opposes thermal expansion of the operating conductive plates. Further, maintaining the fuel cell is complicated by the presence of this resin cover.

### SUMMARY OF THE INVENTION

The aforementioned solutions therefore do not give entire satisfaction.

An object of the invention is to provide an inexpensive fuel cell, adapted for avoiding the occurrence of short-circuits between the conductive plates of the cell, and with easy maintenance.

A fuel cell is provided, in which the membrane is positioned relatively to the conductive plates so that an outer peripheral edge of the membrane juts out towards the outside of the stack relatively to the conductive plates, so as to elongate the air leak lines between said conductive plates.

In particular embodiments of the invention, the fuel cell has one or several of the following features, taken individually or according to any technically possible combination(s):

the outer peripheral edge of the membrane is left free;

each conductive plate has a peripheral outer edge which is at a distance D from the outer peripheral edge of the other conductive plate, and in that the outer peripheral edge of the membrane juts out by a length L relatively to the conductive plates, so that the following relationship is verified: 2×L+D≧1 mm;

the length L is greater than 0.3 mm;

the distance D is strictly less than 0.5 mm, and preferably strictly less than 0.4 mm;

a solid electric insulating layer is interposed between a peripheral outer edge of each conductive plate and the membrane;

the peripheral outer edge of each conductive plate is distanced by more than 0.4 mm from the peripheral outer edge of the other conductive plate.

### BRIEF SUMMARY OF THE DRAWINGS

Other features and advantages of the invention will become apparent upon reading the description which follows, only given as an example and made with reference to the appended drawings, wherein:

FIG. 1 is a sectional view of a half of a fuel cell according to an embodiment of the invention, and

FIG. 2 is a sectional view of a detail of the fuel cell, according to an alternative embodiment of the invention.

### DETAILED DESCRIPTION

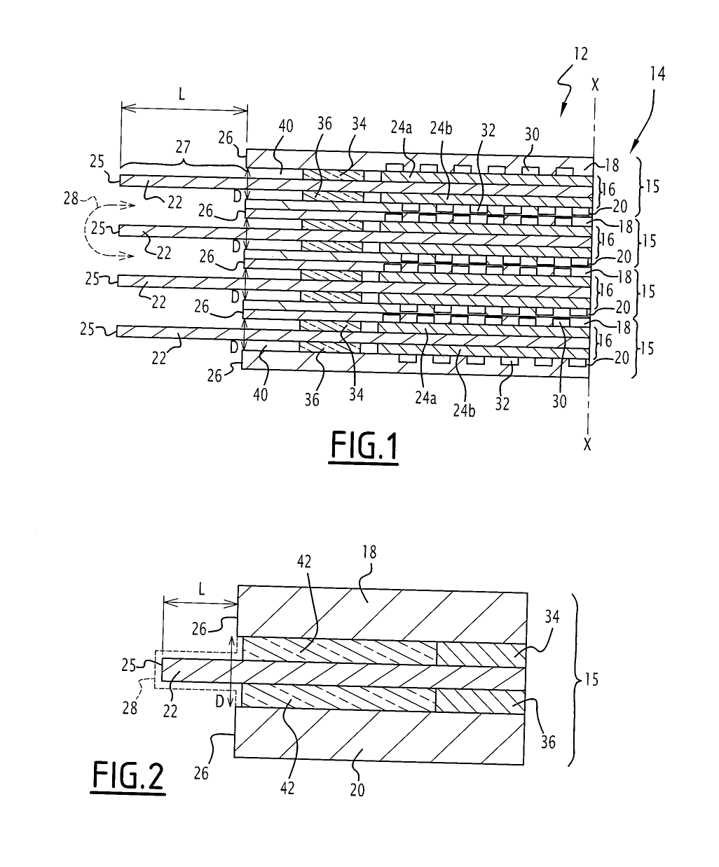

The fuel cell 12, illustrated in FIG. 1, is adapted for producing an electric current by an oxidation-reduction reaction between an oxidizing fluid and a reducing fluid. For this purpose, it comprises a stack 14 of electrochemical cells 15, stacked along a longitudinal stacking direction X.

For reasons of simplification, only one half of the cell 12, cut along a longitudinal median plane, has been illustrated.

Each cell 15 comprises a membrane-electrode assembly 16 inserted along the longitudinal direction X between an anode conductive plate 18 and a cathode conductive plate 20.

The membrane-electrode assembly 16 comprises an ion exchange membrane 22 sandwiched along the longitudinal direction X between an anode 24a and a cathode 24b.

The membrane 22 separates the oxidizing and reducing fluids.

The membrane 22 is generally a proton exchange membrane, adapted for only letting through protons. In particular, the membrane 22 forms a barrier to free electrons. Thus, it electrically insulates the anode 24a of the cathode 24b, and the anode plate 18 from the cathode plate 20.

The membrane 22 is typically in a polymeric material.

An outer peripheral edge 25 of the membrane 22 juts out towards the outside of the cell 15 relatively to the anode 24a and to the cathode 24b, perpendicularly to the longitudinal direction X. The outer peripheral edge 25 juts out over the whole circumference of the membrane 22, so that it extends around the anode 24a and the cathode 24b in a plane perpendicular to the longitudinal direction X. Thus, the anode 24a and the cathode 24b are not flush anywhere with the outer peripheral edge 25 of the membrane 22.

The anode 24a and the cathode 24b each comprise a catalyst, typically of platinum or of platinum alloy, for facilitating the reaction. They are positioned at right angles from each other on either side of the membrane 22, and together define an active area of the cell 15 where the oxidation-reduction reaction occurs.

Each conductive plate 18, 20, has a peripheral outer edge 26. The peripheral outer edges 26 of the conductive plates 18, 20 are substantially aligned along the longitudinal direction X. The peripheral outer edge 26 of each conductive plate 18, 20 juts out towards the outside of the stack 14 relatively to the anode 24a and to the cathode 24b, perpendicularly to the longitudinal direction X, on the whole of the circumference of the conductive plate 18, 20.

The peripheral outer edge 26 of the anode plate 18 is at a distance D, taken along the longitudinal direction X, from the peripheral outer edge 26 of the cathode plate 20.

The outer peripheral edge 25 of the membrane 22 juts out towards the outside of the stack 14 relatively to the conductive plates 18, 20, perpendicularly to the longitudinal direction X. The outer peripheral edge 25 juts out over the whole of the circumference of the membrane 22 by protruding from the conductive plates 18, 20 over the whole circumference of the conductive plates 18, 20 in a plane perpendicular to the longitudinal direction X. Thus, the conductive plates 18, 20 are not flush anywhere with the outer peripheral edge 25 of the membrane 22.

The outer peripheral edge 25 juts out by a length L relatively to the conductive plates 18, 20, the length L being measured between the outer peripheral edge 25 and the orthogonal projection, along the longitudinal direction X, of the outer peripheral edge 26 of each conductive plate 18, 20 on the membrane 22. Preferably, the length L is greater than or equal to 0.2 mm, in particular 0.3 mm.

In any case, the length L verifies with the distance D the following relationship:

2×L+D≧0.4 mm, in particular 2×L+D≧1 mm

Thus the air leak lines between the conductive plates 18, 20 of a same cell, materialized in FIG. 1 by the dotted line 28, has a length greater than 0.4 mm, in particular greater than 1 mm. The electric insulation conditions imposed by the IEC 62282-2 and IEC 62282-3-1 standards are therefore observed.

Preferably, the outer peripheral region 27 of the membrane 22, comprised between the peripheral outer edge 26 of each plate 18, 20 and the outer peripheral edge 25 of the membrane 22, is left free. Thus, it is not taken into a material matrix, for example a matrix of insulating resin.

The anode plate 18 delimits an anode conduit 30 for circulation of the reducing fluid along the anode 24a and in contact with the latter. To do this, the plate 18 is provided with at least one channel made in the face of the plate 18 turned towards the membrane-electrode assembly 16 and closed by said membrane-electrode assembly 16. The anode plate 18 is formed with an electrically conducting material, typically graphite. The reducing fluid used is a fluid comprising dihydrogen, such as for example pure dihydrogen.

The cathode plate 20 delimits a cathode conduit 32 for circulation of the oxidizing fluid along the cathode 24b and in contact with the latter. To do this, the plate 20 is provided with at least one channel made in the face of the plate 20 turned towards the membrane-electrode assembly 16 and closed by said membrane-electrode assembly 16. The cathode plate 20 is formed with an electrically conducting material, typically graphite. The oxidizing fluid used is a fluid comprising dioxygen, such as for example pure dioxygen or a mixture of air and of dioxygen.

The anode 24a is in electric contact with the anode plate 18. The cathode 24b is in electric contact with the cathode plate 20. It is at the anode 24a where oxidation of the reducing fluid occurs and where the electrons and the protons are generated. The electrons then move in transit via the anode plate 18 towards the cathode 24b of a neighboring cell 15, in order to participate in the reduction of the oxidizing fluid in the neighboring cell 15.

In the stack 14, the anode plate 18 of each cell 15 is in contact with the cathode plate 20 of the neighboring cell 15. The conductive plates 18, 20 thus ensure transfer of the electrons of the reducing fluid circulating in one of the cells 15 of the stack 14 towards the oxidizing fluid circulating in another cell 15 of the stack 14. Preferably, a channel for circulation of a cooling fluid, is formed at the interface between the anode 18 and cathode 20 plates.

Alternatively, the anode 18 and cathode 20 plates of two cells 15 neighboring the stack 14 are made in the same material and form together a bipolar plate.

The cell 15 further comprises gaskets 34, 36 for ensuring the seal between the conductive plates 18, 20 on the one hand and the membrane-electrode assembly 16 on the other hand. A first gasket 34 is interposed along the longitudinal direction X between the anode conductive plate 18 and the membrane 22, and a second gasket 36 is interposed along the longitudinal direction X between the cathode conductive plate 20 and the membrane 22, at right angles from the first gasket 34. Each gasket, respectively 34, 36, extends around the anode 24a, respectively or the cathode 24b.

The cells 15 are maintained stacked by clamping plates positioned at the longitudinal ends of the stack 14. Clamping bolts exert a clamping force on these plates for maintaining them in compression against the cells 15.

In the alternative illustrated in FIG. 1, the peripheral outer edge 26 of each conductive plate 18, 20 is at a distance from the membrane 22 along the longitudinal direction X. In other words, the peripheral outer edge 26 is spaced apart from the membrane 22. The distance D is greater than the thickness of the membrane 22.

In particular, an empty space 40 is made between the peripheral outer edge 26 of each conductive plate 18, 20 and the membrane 22. No solid element is positioned in this empty space 40. The manufacturing of the stack 14 is thus facilitated.

The distance D is then preferably strictly less than 0.4 mm. Thus, the size of the stack 14 is limited.

In the alternative illustrated in FIG. 2, a layer 42 of electrically insulating material, typically resin, is deposited between the peripheral outer edge 26 of each conductive plate 18, 20 and the membrane 22. Each layer 42 fills the space between the peripheral outer edge 26 of the corresponding conductive plate 18, 20 of the membrane 22. The outer peripheral edge 25 of the membrane 22 juts out from the layers 42 of insulating material interposed between the membrane 22 and each conductive plate 18, 20, perpendicularly to the longitudinal direction X.

The layers 42 of insulating material and the membrane 22 avoid deposition of a conductive element between the conductive plates 18, 20.

The distance D is then greater than 0.4 mm, in order to observe the IEC 62282-2 and IEC 62282-3-1 standards.

By means of embodiments of the invention, the occurrence of a short circuit between the conductive plates 18, 20 of a same cell 15 is avoided, at a lesser cost. In particular, the air leak lines between the plates 18, 20 are sufficiently long in order to avoid any risk of dielectric breakdown, and the plates 18, 20 are protected from possible outer conductive elements which would come into contact with the stack 14.

Further, access to the elements of the stack 14 is facilitated, which allows easy maintenance of the cell 12.

What is claimed is:

1-9. (canceled)

10. A fuel cell comprising:
a stack of at least one electrochemical cell suitable for generating electric current from an oxidation-reduction reaction between an oxidizing fluid and a reducing fluid, the or each cell including an anode conductive plate delimiting a channel for circulation of the reducing fluid, a cathode conductive plate delimiting a channel for circulation of the oxidizing fluid, and an ion exchanger membrane interposed between the conductive plates, the membrane forming a barrier for free electrons, the membrane being positioned relatively to the conductive plates so that an outer peripheral edge of the membrane juts out towards the outside of the stack relatively to the conductive plates, so as to elongate the air leak lines between the conductive plates.

11. The fuel cell as recited in claim 10 wherein the outer peripheral edge of the membrane is left free.

12. The fuel cell as recited in claim 10 wherein each conductive plate has a peripheral outer edge which is at a distance D from the peripheral outer edge of the other conducive plate, the outer peripheral edge of the membrane jutting out by a length L relatively to the conductive plates, so that the following relationship is verified: 2×L+D≧0.4 mm.

13. The fuel cell as recited in claim 12 wherein the following relationship is verified: 2×L+D≧1 mm.

14. The fuel cell as recited in claim 12 wherein the distance D is strictly less than 0.5 mm.

15. The fuel cell as recited in claim 12 wherein the distance D is strictly less than 0.4 mm.

16. The fuel cell as recited in claim 10 further comprising a solid electric insulating layer interposed between a peripheral outer edge of each conductive plate and the membrane.

17. The fuel cell as recited in claim 16 wherein the peripheral outer edge of each conductive plate is distant by more than 0.4 mm from the peripheral outer edge of the other conductive plate.

18. The fuel cell as recited in claim 10 wherein a peripheral outer edge of the membrane juts out by a length L relatively to the conductive plates, the length L being greater than 0.2 mm.

19. The fuel cell as recited in claim 18 wherein the length L is greater than 0.3 mm.
